(19) United States
(12) Patent Application Publication
(10) Pub. No.: US 2020/0202424 A1
(43) Pub. Date: Jun. 25, 2020

(54) REAL-NAME CONSUMPTION SYSTEM-BASED NEW PENSION SAVING METHOD AND SAVING SYSTEM THEREFOR

(71) Applicant: Hai Ryun KOH, Seoul (KR)

(72) Inventor: Hai Ryun KOH, Seoul (KR)

(21) Appl. No.: 16/608,826

(22) PCT Filed: Apr. 28, 2017
(86) PCT No.: PCT/KR2017/004596

§ 371 Date: Oct. 26, 2019

(51) Int. Cl. G06Q 40/02; G06Q 20/10; G06Q 50/26

(52) U.S. Cl. CPC G06Q 40/02; G06Q 50/26; G06Q 20/10

(57) ABSTRACT

A real-name consumption system-based pension saving system and a method thereof directly associate consumption lives of nationals with a pension to easily acquire financial resources of the pension while ensuring the transparency of economic activities of the nationals. The method includes a pension account opening step for opening a new pension account for an individual and issuing a pension recognizer associated with the new pension account. A pension saving step includes configuring and automatically levying a new consumption pension in a predetermined ratio in an amount of money spent by the individual, crediting the new consumption pension to the new pension account of the individual who has expended the spent amount, and saving the same in the new pension account. A pension payment step includes paying the individual a new pension from a payment time point until the individual dies, according to an amount of money saved in the account.

### TECHNICAL FIELD

The present invention relates to a real-name consumption system-based new pension saving method and a saving system therefor. The present invention relates to a real-name consumption system-based new pension saving method and a saving system therefor, capable of compensating for the weakness of a conventional pension system by automatically saving consumption spent by all nationals through a new pension system, and guaranteeing the basic retirement life for all nationals.

### BACKGROUND ART

In general, a pension system is a kind of social insurances against the risk of loss of income, and it is a system to guarantee a certain level of income against the risk of loss of income existing in daily life. Four public pension systems are in operation for all nationals in Korea as of 2015. Among the public pension systems, a pension system includes a civil service pension scheme for national and local officials, a military pension scheme for military officers and sergeants appointed by officers, that is, for professional soldiers, a private school teacher pension scheme for private school teachers and office workers, and a national pension scheme for general nationals. The pension system aims to secure resources through compulsory collection of insurance premiums and to pay a certain amount of insurance premiums for old ages.

Among the above pension schemes, the national pension scheme is a representative public pension scheme established for all nationals for the purpose of guaranteeing the retirement life for the nationals, in which the nationals are required to save a certain amount of income to receive a certain amount of pension for the retirement life from the age of 65 or older, but the current pension finances in Korea face long-term instability.

In fact, according to the result of the long-term fiscal forecast for the national pension fund announced by the National Pension Fund Operation Committee in 2013, Korea's national pension system is expected to turn into a deficit from 2044, and the fund will be exhausted by 2060, so there are demands to reform the pension system.

In particular, as of 2011, among OECD member countries, the aging population dependency ratio in Korea has reached 15.6%, and the aging population ratio may reach nearly 70% in 2050 due to the unprecedented rapid aging of the population. Thus, it is expected that Korea may become a country having a great burden for supporting the aging population. Due to the rapid aging, the expenditure of the national pension in Korea is expected to increase rapidly in the future. Therefore, if the national pension system is not reformed, various problems such as serious elderly poverty may appear due to the instability of the pension fund.

### RELATED ART DOCUMENT

### Patent Document

(Patent document 1) Registered Patent Publication No. 10-1460586 (2014 Nov. 5)

### DETAILED DESCRIPTION OF THE INVENTION

### Technical Problem

An object of the present invention is to provide a real-name consumption system-based new pension saving method and a saving system therefor, which can directly associate consumption lives of nationals with a pension so as to easily acquire financial resources of the pension while ensuring the transparency of economic activities of the nationals, and thus can apply the pension to all the nationals.

### Technical Solution

The present invention includes: a pension account opening step for opening a new pension account for an individual and issuing a pension recognizer associated with the new pension account; a pension saving step for configuring and automatically levying a new consumption pension in a predetermined ratio in an amount of money spent by the individual, crediting the automatically-levied new consumption pension to the new pension account of the individual who has expended the spent amount, and saving the same in the new pension account; and a pension payment step for paying the individual a new pension from a payment time point until the individual dies, according to an amount of money saved in the new pension account.

### Advantageous Effects of the Invention

According to the present invention, a new pension account is opened at the time of birth and a portion of consumption used before the receipt of the old-age pension is saved and paid as a new pension, so the pension can be paid to all the nationals including not only workers and individual proprietors, but also persons who have difficulty in economic activity and there is no blind spot of pension receipt.

According to the present invention, it is possible to save a new pension even for a family member having difficulty in economic activity by a family pension recognizer, so that entire family members can be guaranteed a stable level of the retirement life.

Since the new pension of the present invention is saved every day from birth to receipt, there is an effect of increasing the savings, and since the new pension is managed in the form of individual property, inheritance is possible, and the burden of sons and daughters for supporting the aging parents can be reduced in terms of economy.

According to the present invention, since saving details are recorded every day, the new pension may serve as an account book for the whole life without a separate account book, and it is possible to reflect the past life and set the direction for the future life based on the saving details.

The new consumption pension of the present invention includes a surplus new consumption pension, so that the income redistribution can be realized according to high value-added consumption, thereby minimizing the income gap according to the receipt of the aging new pension.

The present invention is based on the consumption life of all the nationals, so that the entire demographics can be made automatically, thereby preventing tax evasion and crime, and significantly reducing the work of public institutions.

In addition, according to the present invention, the new pension system is implemented based on the real-name consumption system, thereby preventing the illegal consumption expenditure, reducing the corruption and graft derived from tax evasion, and improving the saving rate of individuals, thus, the national finance and funds can be easily secured.

### DESCRIPTION OF THE DRAWINGS

FIG. 1 is an exemplary block diagram showing a new pension saving method according to the present invention.

FIG. 2 is an exemplary view showing a flow of a new pension saving according to the present invention.

FIG. 3 is an exemplary view showing a new pension saving system according to the present invention.

### BEST MODE

### Mode for Invention

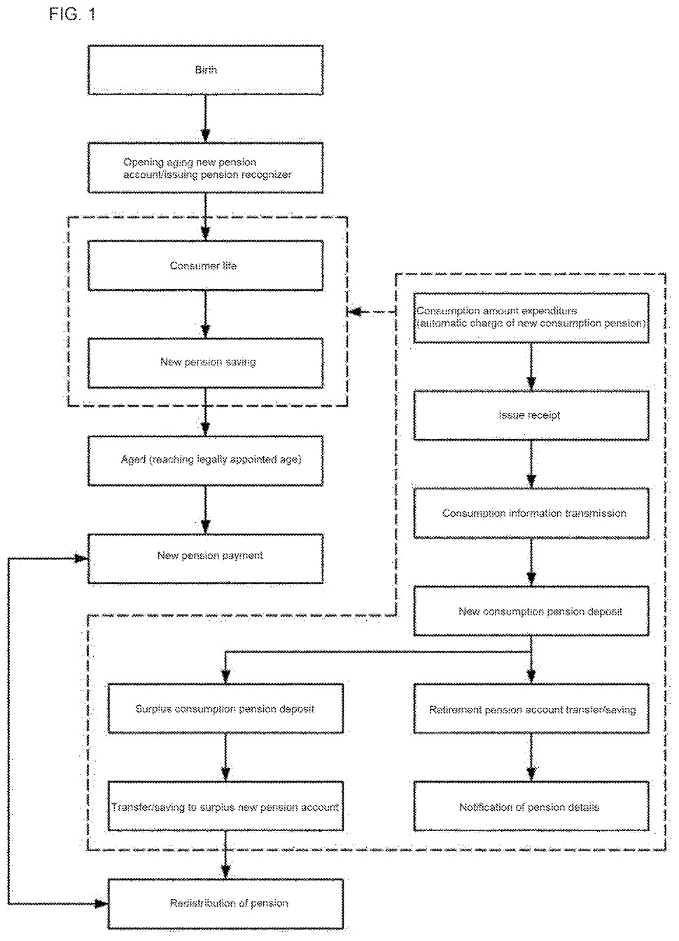

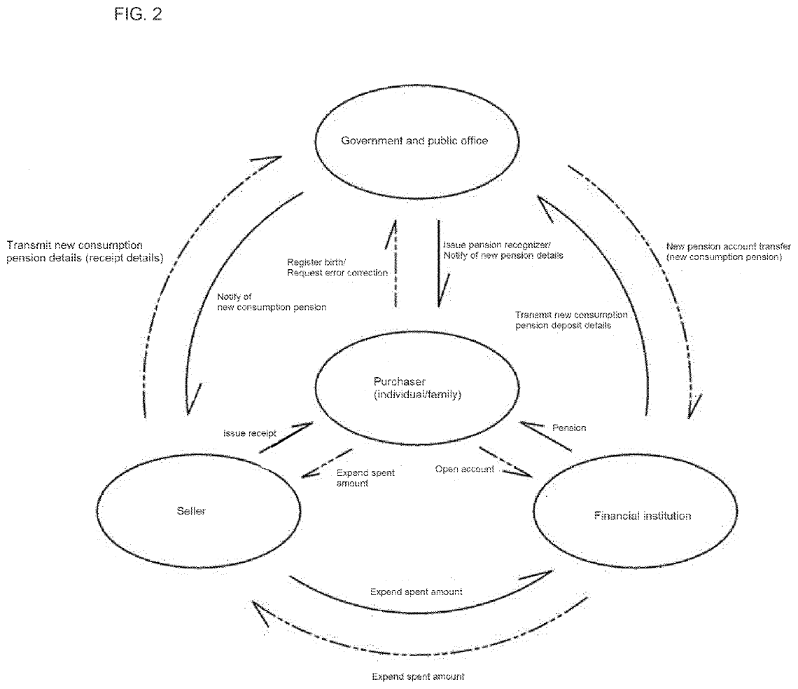

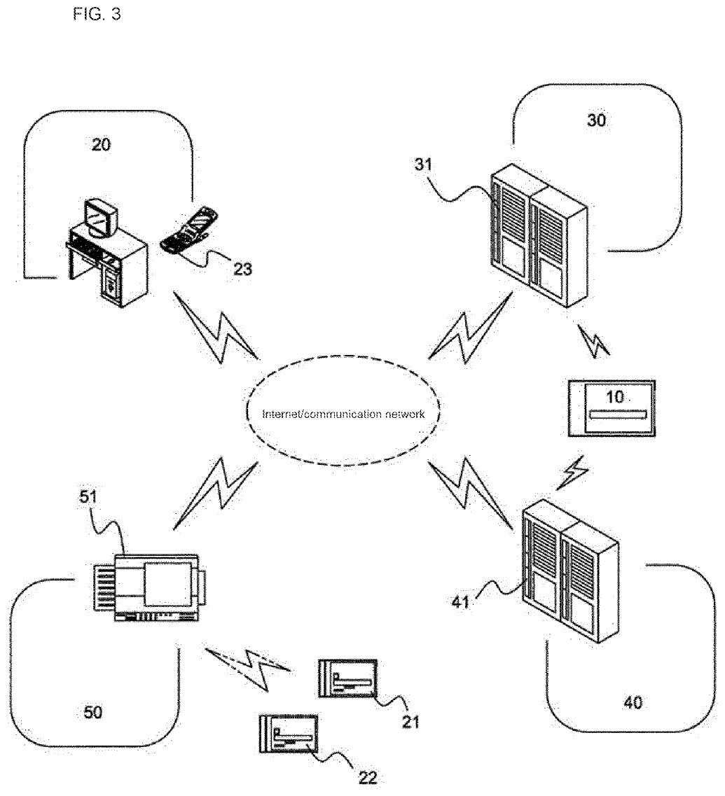

FIG. 1 is an exemplary block diagram showing a new pension saving method according to the present invention, FIG. 2 is an exemplary view showing a flow of a new pension saving according to the present invention, and FIG. 3 is an exemplary view showing a new pension saving system according to the present invention. According to the present invention, a part of individual's consumption is automatically collected as a new consumption pension for saving the new pension, the collected new consumption pension is automatically deposited in the individual's new pension account, and the deposit in the new pension account is paid to the individual as a new pension until the death of individual.

That is, the present invention includes a pension account opening step for opening a new pension account 10 for an individual by a computer system of a financial institution or a government office and transmitting an issuing of a pension recognizer 21 associated with the new pension account to the computer system of the government office;

a pension saving step, in which a new consumption pension which is set at a certain rate of an individual consumption is automatically collected and transferred and deposited to the new pension account 10 in the government office or financial institution, and the deposited new consumption pension is saved in an individual pension account of a purchaser who performs a consumption; and

a pension payment step for paying the new pension to the individual through the computer system of the government office from a payment time point until the individual dies depending on an amount of money saved in the new pension account.

In the pension account opening step, the new pension account 10 is opened in the name of a user with a birth registration, and the individual pension recognizer 21 is issued in association with the new pension account 10. The opening of the new pension account 10 and the issuance of the individual pension recognizer 21 may be carried out at a financial institution 40 or a government office 30 and the details of the account opening and the issuance history of the individual pension recognizer are transmitted to a computer system 31 of the government office.

In addition, the individual pension recognizer 21 may be made in the form of a card, an ID card, and the like, and may be equipped with a self-authentication function and a connection function to the new pension account.

In addition, the government office 30 may refer to an existing certification organization such as an existing pension management institution, a ward office, a community service center, city hall, etc., and may refer to a new pension management institution for collectively managing the new pension system according to the present invention.

The new pension account 10 is managed by the financial institution 40 such as a bank, and a predetermined interest determined by the law according to the deposit amount is automatically paid to the new pension account 10. In this case, the interest is calculated and paid with a compound interest or a single interest, and preferably, calculated and paid with the compound.

In addition, the account opening step further includes issuing or registering the family pension recognizer 22.

The family pension recognizer 22 improves the phenomenon in which the amount of money spent for the family life is concentratedly deposited in the new pension account of one person and allows the new pension to be deposited in the pension account of family members, such as minors and the elderly who have difficulty in economic activities. The family pension recognizer is to register information on a number of persons having the family relationship and is linked the new pension accounts of the registered individuals, so unlike the individual pension recognizer, the new consumption pension added to the consumption amount is divided into 1/N per registered persons N and deposited into the individual new pension accounts.

For example, when a consumer purchases a car having a price of 30 million won (consumption amount) while the new consumption pension and VAT are set at 10%, respectively, the 30 million won may include VAT of 2.5 million won (10%), new consumption pension of 2.5 million won (10%) and a supply value of 25 million won. If the consumer presents the individual pension recognizer to the seller with the consumption amount of 30 million won, the entire new consumption pension of 2.5 million won is deposited into the new pension account of the consumer.

In this case, since the car may be commonly used for the family, when the family pension recognizer (for example: four family members) is presented to the seller together with the consumption amount of 30 million won, the new consumption pension of 2.5 million won is divided to four family members, so that 625,000 won may be deposited into the individual pension accounts of the family members.

Similar to the individual pension recognizer 21, the family pension recognizer 22 as described above is issued from the financial institution 40 or the government office 30, and is provided corresponding to the number of registered persons only when a certificate for the family relationship is submitted.

In the pension saving step, the new consumption pension included in the consumption amount of the individual or family is automatically deposited into the individual new pension account 10. In this case, the consumption amount is an amount in which the new consumption pension is added to the supply value for the goods purchased by the individual or the family, or services provided, that is, the amount of expenses paid to the seller (the amount of expenses including taxes, such as VAT, etc. determined by the law).

The new consumption pension has the feature of a pension which is added at a certain rate to the supply value of all the goods to be purchased by the individual or family or the supply value of the service to be provided and is compulsorily collected. The new consumption pension is added to the supply value price to secure the financial resources for the pension system according to the present invention.

That is, since 1977 in Korea, a value added tax (VAT) which is imposed to the additional value created at each stage of the production and distribution processes has been forcibly added to the supply value, and the VAT is 10% of the supply value as of 2015. In this regard, according to the present invention, an additional new consumption pension is added to the supply value at a certain rate (for example, in the range of 0.1 to 20%, preferably about 5 to 10%) separately from the VAT in such a manner that the new consumption pension can be automatically added upon expenditure (consumption amount) of the individual or family.

In addition, the new consumption pension includes a surplus new consumption pension, and the surplus new consumption pension is to prevent the phenomenon of ‘the rich get richer while the poor get poorer’ caused by the difference in the amount of consumption according to the income level. Substantially, the new consumption pension has a redistribution function of income.

That is, an upper limit of the amount of the individual pension, which can be deposited into the new pension account 10 of the individual and family, is set in the new consumption pension, and the amount exceeding the upper limit is set as the surplus new consumption pension such that the amount corresponding to the surplus new consumption pension can be automatically deposited into the surplus new consumption pension accounts other than the individual new pension accounts.

The surplus new consumption pension is used as a fund when there is a shortage of payment of the new pension or in order to guarantee the minimum new pension payment (redistribution of new pension according to the standard income level) and an account for the surplus new consumption pension is managed by an official group, such as a country that pays for the new pension.

In addition, the set amount of the surplus new consumption pension, that is, the upper limit of the target amount of the individual pension may be set by summing the lowest price and the highest price for the goods and then dividing the sum at a predetermined ratio, however, it is recommended to be set by the country based on price information and data of the National Statistical Office and National Tax Service in a unit of one year, three years and five years to reflect the real situation.

Further, the surplus new consumption pension may be imposed to only a corresponding article by classifying a specific article group or to all articles, and an addition ratio of the surplus new consumption pension may be set differently depending on the articles.

That is, the surplus new consumption pension may be added upon the purchase of expensive goods and excessive expenditure. For example, in a state in which the new consumption pension is set to 10% of the supply value, and the upper limit of the new consumption pension is set to three million won for all the goods, if a single household owner purchases a luxury car of 90 million won,

the consumption amount of 90 million won includes the VAT of 7.5 million won, the new consumption pension of 7.5 million won, and the supply value of 75 million won. In this situation, if the single household owner A pays 90 million won to the seller, 7.5 million won has to be deposited into the new pension account of the single household owner A as the new consumption pension. However, actually, the upper limit value of 3 million won is deposited into the new pension account of the single household owner A and the remaining 4.5 million won is automatically deposited into the surplus new consumption account.

In addition, the new consumption pension may further include a house securement cost. The house securement cost is for securing a stable residence when it reaches the new pension receipt age, in which the house securement cost is saved separately from the new pension by setting the house securement cost at a predetermined ratio of the new consumption pension. The house securement cost may be set within the range of about 10 to 30% of the new consumption pension.

In other words, if it is scheduled that the new consumption pension of 1 million won is deposited into a new consumption pension account of a person B, 100,000 to 300,000 won of the new consumption pension is separately saved as the house securement cost and only the remaining 700,000 to 900,000 won is deposited into the new pension account. The house securement cost, which is separately saved, may be used as a rental cost for the housing provided by the government or as a purchase cost for the housing when it reaches the pension receipt age. The house purchase cost may be paid at a time or may be paid in installments over a period of time like the loan repayment. In addition, the remaining amount of money used as a house purchase fund may be paid to a recipient of the new pension at a time, or may be inherited by a legal heir at the death of the recipient of the new pension.

The saving of the house securement cost is to solve the difficulty in the retirement life due to homelessness, and to ensure the stable retirement life by securing the residence or minimum residential cost with the receipt of the new pension.

The pension saving step may include:

a receipt issuing step of automatically issuing a receipt depending on an input consumption amount after information of the purchaser in the recognizer is recognized by a recognition terminal provided at a selling place;

a consumption information transmitting step of inputting issuing details of the receipt into the computer system of the government office and a terminal system of the individual;

a new consumption pension depositing step of automatically transferring an amount corresponding to the new consumption pension based on the issued receipt from a seller or a card company to the new pension account of the government office or the financial institution; and

an account depositing step of depositing the new consumption pension, which is deposited in the new pension account of the public office or financial institution, into the new pension account of the individual by the computer system of the public office depending on the details of the receipt inputted into the public office.

The account depositing step may further include a surplus new consumption pension depositing step of depositing a surplus new consumption pension by transferring the surplus new consumption pension to the surplus new pension account after determining the surplus new consumption pension for the new consumption pension based on the receipt.

In addition, the pension saving step may further include a deposit history notifying step of notifying the individual of the deposit details after the account depositing step.

The receipt issuing step may include automatically issuing the receipt depending on an input consumption amount after information in the individual pension recognizer 21 or family pension recognizer 22 is recognized by the recognition terminal 51 provided at the selling place 50. In this case, the recognition terminal 51 may be a card terminal which is currently used or a separate pension recognition terminal installed with a program capable of recognizing information in the individual pension recognizer or family pension recognizer.

In addition, it is desirable that the issued receipt be kept about 5 years by both the purchaser and the seller or at least by the seller, and if necessary, the storage of the receipt may be compulsorily ruled. The duty of the mandatory storage of the receipt is to enable the purchaser, the seller, and the government office to correct errors promptly and accurately that may occur in the future when confirming the deposit of the pension.

Further, the receipt issuing step is preceded by a consumption amount expenditure step in which the consumption amount is paid to the seller as a reward for goods or services provided by the seller. In other words, in the consumption amount expenditure step, the consumption amount according to the individual expenditure or family expenditure of the purchaser is paid to the seller, and the individual pension recognizer 21 or the family pension recognizer 22 for the new pension saving may be given to the seller depending on the nature of the expenditure. In this case, the consumption amount corresponding to the purchaser's expenditure may be paid to the seller by cash or card.

In the consumption information transmitting step, the details of the issued receipt, that is, the amount of consumption spent in the name of the individual or family is automatically transmitted to the computer system 31 of the government office and the terminal system 23 of the individual at the receipt is issued. The terminal system 23 of the individual may refer to a device such as a mobile phone, a computer, etc., in which the individual can check the details.

In the new consumption pension depositing step, the new consumption pension posted on the receipt is automatically deposited by the seller into the new pension account of the government office (new pension management institution) or the financial institution, immediately. When the purchaser purchases the good by cash, it is mandatory for the seller to issue a cash receipt and the new consumption pension has to be automatically transferred by cash, immediately. When purchasing with a credit card, it is mandatory for the card company to immediately deposit the amount corresponding to the new consumption pension into the new pension account. Such a new consumption pension depositing step may be performed by establishing a separate system such that the new consumption pension can be transferred in real time to the individual new consumption pension account.

The account depositing step may include the following four steps. That is, the account depositing step may include: a comparing step of comparing, by the computer system of the government office, the amount of the new consumption pension of the individual based on the details of the received receipt with the amount of the new consumption pension deposited for the individual;

a depositing step of automatically depositing the amount of the new consumption pension from the computer system of the government office to the individual new pension account through the computer system of the financial institution when the amount of the new consumption pension based on the receipt matches the amount of the deposited new consumption pension;

an error notifying step of notifying the purchaser and seller of an error of the new consumption pension by the computer system of the government office when the amount of the new consumption pension based on the receipt does not match the amount of the deposited new consumption pension; and

a correcting step of correcting the error in response to the error notifying step based on clarification data of the purchaser and seller or details of the deposit for the erroneous new consumption pension.

The account depositing step may be automatically performed by a computer processing system (computer system 31) of the government office and a computer processing system 41 of the financial institution and the new consumption pension for the consumption amount spent in the name of the individual or family is deposited and saved to the new pension accounts 10 of the individuals. In other words, the new consumption pension posted on the receipt is compared with the amount of the deposited new consumption pension by the computer system 31 of the government office and the deposit of the new consumption pension is automatically transferred to the account of the individual from the computer system of the government office through the computer system of the financial institution where there is no error.

In the deposit history notifying step, the payment history deposited into the individual pension account is notified to the individual from the computer system of the government office by a notification device such as a mail or the Internet, so that the individual may confirm the pension deposit history, in which the deposit history where the details of the deposit of the new consumption pension are arranged is notified to the individual from the government office in the deposit cycle of the new compensation pension, that is, monthly or quarterly. In this case, the deposit history is automatically prepared and processed by the computer system installed in the government office, and the new consumption pension and the surplus new consumption pension are separately posted on the deposit history.

In addition, although the new pension system of the present invention is based on the real-name consumption system, the benefit of the new pension system may be insignificant in the case of a frugal consumer. In order to compensate for the above problem, the individual may directly save the new consumption pension by depositing a predetermined amount of money into the new pension account like a bank deposit and the details of the direct deposit into the new pension account may be notified to the individual at the deposit detail notifying step so that the individual can confirm the pension deposit details.

In the pension payment step, the new pension amount deposited into the individual new pension account is paid to the individual in the form of pension every month. For example, the pension is paid from the age of 65 years old, which is the pension receipt age in Korea, until death. Since the new pension is saved according to the consumption life of the individuals, the new pension may be paid separately from other pensions that are already being paid.

Hereinafter, the present invention will be described in detail with reference to embodiments.

The following embodiments are simulation results obtained by assuming that the new consumption pension and surplus new consumption pension according to the present invention are deposited from 28 to 63 years old by classifying the persons into a low-income group, a middle-income (average income group) and a high-income group according to the income level.

The monthly disposable income was set based on a person having 28 years old as “1.3 million won for low-income group, 2 million won for middle-income group, and 3.5 million won for high-income group” and the monthly disposable income was set up to 63 years old while assuming that a monthly income growth rate is 2%.

In addition, the average consumption propensity of the corresponding age group was obtained from the statistics data of National Statistical Office, and the consumption amount was represented as “monthly disposable income×average consumption propensity”.

Further, the consumption amount for the non-necessary goods was calculated by setting at 20% for the low-income group, 40% for the middle-income group, and 60% for the high-income group from among the targets of the surplus new consumption pension.

The new consumption pension was calculated by setting “10% of necessary good consumption amount+5% of non-necessary good consumption amount”, and the surplus new consumption pension was calculated by setting “5% of non-necessary good consumption amount” (consumption amount for the non-necessary goods is for a specific item that is subject to the surplus new consumption pension. In the embodiment below, in 10% of the non-necessary good consumption amount, 5% was set for the new consumption pension and the remaining 5% was set for the surplus consumption pension. New consumption pension=necessary good consumption amount×0.1+non-necessary good consumption amount×0.05, surplus new consumption pension=non-necessary good consumption amount×0.05).

In addition, annual new consumption pension (or annual surplus new consumption pension) was calculated by applying 3% compounding to the new consumption pension (or annual surplus new consumption pension), which is deposited at the corresponding age, until 63 years old.

### Embodiment 1

The new consumption pension and surplus new consumption pension deposits for one person of the low-income group over ages are shown in Table 1, and the amount paid for 35 years was 68.85 million won for the new consumption pension and 7.65 million won for the surplus new consumption pension.

TABLE 1

| | | | | | non- | | | | Annual |
|---|---|---|---|---|---|---|---|---|---|
| | | | | Necessary | necessary | | | Annual new | surplus new |
| | Monthly | Average | | good | good | New | Surplus new | consumption | consumption |
| | disposal | consumption | Consumption | consumption | consumption | consumption | consumption | pension | pension (3% |
| Age | income | propensity | amount | amount | amount | pension | pension | (3% growth) ¹⁾ | growth) |
| 28 | 130.0 | 0.74 | 96.7 | 77.0 | 19.2 | 8.7 | 1.0 | 292.3 | 32.5 |
| 29 | 132.6 | 0.74 | 98.1 | 78.5 | 19.6 | 8.8 | 1.0 | 289.5 | 32.2 |
| 30 | 135.3 | 0.57 | 76.9 | 61.5 | 15.4 | 6.9 | 0.8 | 220.1 | 24.5 |
| 31 | 138.0 | 0.57 | 78.4 | 62.7 | 15.7 | 7.1 | 0.8 | 218.0 | 24.2 |
| 32 | 140.7 | 0.57 | 79.9 | 63.9 | 16.0 | 7.2 | 0.8 | 215.8 | 24.0 |
| 33 | 143.5 | 0.57 | 81.5 | 65.2 | 16.3 | 7.3 | 0.8 | 213.7 | 23.7 |
| 34 | 146.4 | 0.57 | 83.2 | 66.8 | 16.6 | 7.5 | 0.8 | 211.6 | 23.5 |
| 35 | 149.3 | 0.57 | 84.8 | 67.8 | 17.0 | 7.6 | 0.8 | 209.5 | 23.3 |
| 36 | 152.3 | 0.57 | 86.5 | 69.2 | 17.3 | 7.8 | 0.9 | 207.5 | 23.1 |
| 37 | 155.4 | 0.57 | 88.3 | 70.6 | 17.7 | 7.9 | 0.9 | 205.6 | 22.8 |
| 38 | 158.5 | 0.57 | 90.0 | 72.0 | 18.0 | 8.1 | 0.9 | 203.6 | 22.6 |
| 39 | 161.6 | 0.57 | 91.8 | 73.4 | 18.4 | 8.3 | 0.9 | 201.5 | 22.4 |
| 40 | 164.9 | 0.58 | 95.2 | 76.2 | 19.0 | 8.6 | 1.0 | 203.0 | 22.6 |
| 41 | 168.2 | 0.58 | 97.1 | 77.7 | 19.4 | 8.7 | 1.0 | 201.0 | 22.3 |
| 42 | 171.5 | 0.58 | 99.0 | 79.2 | 19.8 | 8.9 | 1.0 | 199.0 | 22.1 |
| 43 | 175.0 | 0.58 | 101.1 | 80.9 | 20.2 | 9.1 | 1.0 | 197.1 | 21.9 |
| 44 | 178.5 | 0.58 | 103.1 | 82.5 | 20.6 | 9.3 | 1.0 | 195.2 | 21.7 |
| 45 | 182.0 | 0.58 | 105.1 | 84.1 | 21.0 | 9.5 | 1.1 | 193.2 | 21.5 |
| 46 | 185.7 | 0.58 | 107.2 | 85.8 | 21.4 | 9.7 | 1.1 | 191.4 | 21.3 |
| 47 | 189.4 | 0.58 | 109.4 | 87.5 | 21.9 | 9.8 | 1.1 | 189.6 | 21.1 |
| 48 | 193.2 | 0.58 | 111.6 | 89.3 | 22.3 | 10.0 | 1.1 | 187.7 | 20.9 |
| 49 | 197.0 | 0.58 | 113.8 | 91.0 | 22.8 | 10.2 | 1.1 | 185.9 | 20.7 |
| 50 | 201.0 | 0.50 | 99.9 | 79.9 | 20.0 | 9.0 | 1.0 | 158.4 | 17.6 |
| 51 | 205.0 | 0.50 | 101.9 | 81.5 | 20.4 | 9.2 | 1.0 | 156.9 | 17.4 |
| 52 | 209.1 | 0.50 | 103.9 | 83.1 | 20.8 | 9.4 | 1.0 | 155.4 | 17.3 |
| 53 | 213.3 | 0.50 | 106.0 | 84.8 | 21.2 | 9.5 | 1.1 | 153.9 | 17.1 |
| 54 | 217.5 | 0.50 | 108.1 | 86.5 | 21.6 | 9.7 | 1.1 | 152.3 | 16.9 |
| 55 | 221.9 | 0.50 | 110.3 | 88.2 | 22.1 | 9.9 | 1.1 | 160.9 | 16.8 |
| 56 | 226.3 | 0.50 | 112.5 | 90.0 | 22.5 | 10.1 | 1.1 | 149.4 | 16.6 |
| 57 | 230.9 | 0.50 | 114.8 | 91.8 | 23.0 | 10.3 | 1.1 | 148.0 | 16.4 |
| 58 | 235.5 | 0.50 | 117.0 | 93.6 | 23.4 | 10.5 | 1.2 | 146.5 | 16.3 |
| 59 | 240.2 | 0.50 | 119.4 | 95.5 | 23.9 | 10.7 | 1.2 | 145.1 | 16.1 |
| 60 | 145.0 | 0.50 | 120.1 | 96.0 | 24.0 | 10.8 | 1.2 | 141.7 | 15.7 |
| 61 | 249.9 | 0.70 | 174.9 | 139.9 | 35.0 | 15.7 | 1.7 | 200.4 | 22.3 |
| 62 | 254.9 | 0.70 | 178.4 | 142.7 | 35.7 | 16.1 | 1.8 | 198.5 | 22.1 |
| 63 | 260.0 | 0.70 | 182.0 | 145.6 | 36.4 | 16.4 | 1.8 | 196.6 | 21.8 |

Final current value of final new pension deposit: KRW 6.855 million; Surplus new consumption pension: KRW 7.65 million (assuming real 3% return on investment)
¹⁾ New consumption pension = (Monthly new pension tax * 12) \hat{ } (63-age), and annual surplus new apportioned tax is also calculated in the same manner

### Embodiment 2

The new consumption pension and surplus new consumption pension deposits for one person of the middle-income group over ages are shown in Table 2, and the amount paid for 35 years was 94.20 million won for the new consumption pension and 23.55 million won for the surplus new consumption pension.

TABLE 2

| | | | | | non- | | | | Annual |
|---|---|---|---|---|---|---|---|---|---|
| | | | | Necessary | necessary | | | Annual new | surplus new |
| | Monthly | Average | | good | good | New | Surplus new | consumption | consumption |
| | disposal | consumption | Consumption | consumption | consumption | consumption | consumption | pension | pension (3% |
| Age | income | propensity | amount | amount | amount | pension | pension | (3% growth) | growth) |
| 28 | 200 | 0.74 | 148.00 | 118.40 | 29.60 | 13.32 | 1.48 | 449.22 | 49.97 |
| 29 | 204 | 0.74 | 150.96 | 120.77 | 30.19 | 13.59 | 1.51 | 445.40 | 49.49 |
| 30 | 208.1 | 0.57 | 118.20 | 94.56 | 23.64 | 10.64 | 1.18 | 338.59 | 37.62 |
| 31 | 212.2 | 0.57 | 120.53 | 96.42 | 24.11 | 10.85 | 1.21 | 335.20 | 37.24 |
| 32 | 216.5 | 0.57 | 122.97 | 98.38 | 24.59 | 11.07 | 1.23 | 332.04 | 36.89 |
| 33 | 220.8 | 0.57 | 125.41 | 100.33 | 25.08 | 11.29 | 1.25 | 328.77 | 36.53 |
| 34 | 225.2 | 0.57 | 127.91 | 102.33 | 25.58 | 11.51 | 1.28 | 325.55 | 36.17 |
| 35 | 229.7 | 0.57 | 130.47 | 104.38 | 26.09 | 11.74 | 1.30 | 322.39 | 35.82 |
| 36 | 234.3 | 0.57 | 133.08 | 106.47 | 26.62 | 11.98 | 1.33 | 319.26 | 35.47 |
| 37 | 239 | 0.57 | 135.75 | 108.60 | 27.15 | 12.22 | 1.36 | 316.18 | 35.13 |
| 38 | 243.8 | 0.57 | 138.48 | 110.78 | 27.70 | 12.46 | 1.38 | 313.14 | 34.79 |
| 39 | 248.7 | 0.57 | 141.26 | 113.01 | 23.25 | 12.71 | 1.41 | 310.13 | 34.46 |
| 40 | 253.6 | 0.58 | 146.45 | 117.16 | 29.29 | 13.13 | 1.46 | 312.16 | 34.68 |
| 41 | 258.7 | 0.58 | 149.40 | 119.52 | 29.88 | 13.45 | 1.49 | 309.17 | 34.35 |
| 42 | 263.9 | 0.58 | 152.40 | 121.92 | 30.48 | 13.72 | 1.52 | 306.19 | 34.02 |
| 43 | 269.2 | 0.58 | 155.46 | 124.37 | 31.09 | 13.99 | 1.55 | 303.25 | 33.69 |
| 44 | 274.6 | 0.53 | 158.58 | 126.87 | 31.72 | 14.27 | 1.59 | 300.32 | 33.37 |
| 45 | 280 | 0.58 | 161.70 | 129.36 | 32.34 | 14.55 | 1.62 | 297.31 | 33.03 |
| 46 | 285.6 | 0.58 | 164.93 | 131.95 | 32.99 | 14.84 | 1.65 | 294.42 | 32.71 |
| 47 | 291.4 | 0.58 | 168.23 | 134.63 | 33.66 | 15.15 | 1.68 | 291.65 | 32.41 |
| 48 | 297.2 | 0.58 | 171.63 | 137.31 | 34.33 | 15.45 | 1.72 | 288.79 | 32.09 |
| 49 | 303.1 | 0.53 | 175.04 | 140.03 | 35.01 | 15.75 | 1.75 | 285.95 | 31.77 |
| 50 | 309.2 | 0.50 | 153.67 | 122.94 | 30.73 | 13.83 | 1.54 | 243.73 | 27.08 |
| 51 | 315.4 | 0.50 | 156.75 | 125.40 | 31.35 | 14.11 | 1.57 | 241.37 | 26.82 |
| 52 | 321.7 | 0.50 | 159.83 | 127.91 | 31.98 | 14.39 | 1.60 | 239.02 | 26.56 |
| 53 | 328.1 | 0.50 | 163.07 | 130.45 | 32.61 | 14.68 | 1.63 | 236.68 | 26.30 |
| 54 | 334.7 | 0.50 | 166.35 | 133.03 | 33.27 | 14.97 | 1.66 | 234.41 | 26.05 |
| 55 | 341.4 | 0.50 | 169.68 | 135.74 | 33.94 | 15.27 | 1.70 | 232.14 | 25.79 |
| 56 | 348.2 | 0.50 | 173.06 | 138.44 | 34.61 | 15.57 | 1.73 | 229.86 | 25.54 |
| 57 | 355.2 | 0.50 | 176.53 | 141.23 | 35.31 | 15.89 | 1.77 | 227.65 | 25.29 |
| 58 | 362.3 | 0.50 | 180.06 | 144.05 | 36.01 | 16.21 | 1.80 | 225.44 | 25.05 |
| 59 | 369.5 | 0.50 | 183.64 | 146.91 | 36.73 | 16.53 | 1.84 | 223.23 | 24.80 |
| 60 | 376.9 | 0.49 | 184.68 | 147.74 | 36.94 | 16.62 | 1.85 | 217.95 | 24.22 |
| 61 | 384.4 | 0.70 | 269.08 | 215.26 | 53.82 | 24.22 | 2.69 | 308.30 | 34.26 |
| 62 | 392.1 | 0.70 | 274.47 | 219.58 | 54.89 | 24.70 | 2.24 | 305.32 | 33.92 |
| 63 | 400 | 0.70 | 280.00 | 224.00 | 56.00 | 25.20 | 2.80 | 302.40 | 33.60 |

Final current value of final new pension deposit: KRW 94.20 million, Surplus new consumption pension: KRW 23.55 million (assuming real 3% return on investment)

### Embodiment 3

The new consumption pension and surplus new consumption pension deposits for one person of the high-income group over ages are shown in Table 3, and the amount paid for 35 years was 145.00 million won for the new consumption pension and 61.80 million won for the surplus new consumption pension.

TABLE 3

| | | | | | Non- | | | | Annual |
|---|---|---|---|---|---|---|---|---|---|
| | | | | Necessary | necessary | | | Annual new | surplus new |
| | Monthly | Average | | good | good | New | Surplus new | consumption | consumption |
| | disposal | consumption | Consumption | consumption | consumption | consumption | consumption | pension | pension (3% |
| Age | income | propensity | amount | amount | amount | pension | pension | (3% growth) | growth) |
| 28 | 350.0 | 0.74 | 259.00 | 103.60 | 155.40 | 18.13 | 7.77 | 612.18 | 262.36 |
| 29 | 357.0 | 0.74 | 264.18 | 105.67 | 158.51 | 18.49 | 7.93 | 606.24 | 259.82 |
| 30 | 364.1 | 0.71 | 258.54 | 103.42 | 155.12 | 18.10 | 7.76 | 576.02 | 246.86 |
| 31 | 371.4 | 0.71 | 263.71 | 105.48 | 158.23 | 18.46 | 7.91 | 570.42 | 244.47 |
| 32 | 378.9 | 0.71 | 268.98 | 107.59 | 161.39 | 18.83 | 8.07 | 564.89 | 242.09 |
| 33 | 386.4 | 0.71 | 274.36 | 109.75 | 164.62 | 19.21 | 8.23 | 559.40 | 239.74 |
| 34 | 394.2 | 0.71 | 279.85 | 111.94 | 167.91 | 19.59 | 8.40 | 553.97 | 237.42 |
| 35 | 402.0 | 0.71 | 285.45 | 114.18 | 171.27 | 19.98 | 8.56 | 548.59 | 235.11 |
| 36 | 410.1 | 0.71 | 291.16 | 116.46 | 174.69 | 20.38 | 3.73 | 543.27 | 232.83 |
| 37 | 418.3 | 0.71 | 296.98 | 118.79 | 178.19 | 20.79 | 8.91 | 537.99 | 230.57 |
| 38 | 426.6 | 0.71 | 302.92 | 121.17 | 181.75 | 21.20 | 9.09 | 532.77 | 228.33 |
| 39 | 435.2 | 0.71 | 308.98 | 123.59 | 185.39 | 21.63 | 9.27 | 527.60 | 226.11 |
| 40 | 443.9 | 0.77 | 341.79 | 136.72 | 205.07 | 23.93 | 10.25 | 566.63 | 242.84 |
| 41 | 452.8 | 0.77 | 348.63 | 139.45 | 209.18 | 24.40 | 10.46 | 561.12 | 240.48 |
| 42 | 461.8 | 0.77 | 355.60 | 142.24 | 213.36 | 24.89 | 10.67 | 555.68 | 238.15 |
| 43 | 471.1 | 0.77 | 362.71 | 145.08 | 217.63 | 25.39 | 10.88 | 550.28 | 235.84 |
| 44 | 480.5 | 0.77 | 369.97 | 147.99 | 221.98 | 25.90 | 11.10 | 544.94 | 233.55 |
| 45 | 490.1 | 0.77 | 377.37 | 150.95 | 226.42 | 26.42 | 11.32 | 539.65 | 231.28 |
| 46 | 499.9 | 0.77 | 384.91 | 153.96 | 230.95 | 26.94 | 11.55 | 534.41 | 229.03 |
| 47 | 509.9 | 0.77 | 392.61 | 157.04 | 235.57 | 27.48 | 11.78 | 529.22 | 226.81 |
| 48 | 520.1 | 0.77 | 400.46 | 160.19 | 240.28 | 28.03 | 12.01 | 524.08 | 224.61 |
| 49 | 530.5 | 0.77 | 408.47 | 163.39 | 245.08 | 28.59 | 12.25 | 518.99 | 222.43 |
| 50 | 541.1 | 0.71 | 384.18 | 153.67 | 230.51 | 26.89 | 11.53 | 573.91 | 203.10 |
| 51 | 551.9 | 0.71 | 391.86 | 156.74 | 235.12 | 27.43 | 11.76 | 469.31 | 201.13 |
| 52 | 563.0 | 0.71 | 399.70 | 159.88 | 239.82 | 27.98 | 11.99 | 464.75 | 199.18 |
| 53 | 574.2 | 0.71 | 407.69 | 163.08 | 244.61 | 28.54 | 12.23 | 460.24 | 197.24 |
| 54 | 585.7 | 0.71 | 415.84 | 166.34 | 249.51 | 29.11 | 12.48 | 455.77 | 195.33 |
| 55 | 597.4 | 0.71 | 424.16 | 169.66 | 254.50 | 29.69 | 12.72 | 451.34 | 193.43 |
| 56 | 609.4 | 0.71 | 432.64 | 173.06 | 259.59 | 30.29 | 12.98 | 446.96 | 191.56 |
| 57 | 621.5 | 0.71 | 441.30 | 176.52 | 264.78 | 30.89 | 13.24 | 442.62 | 189.70 |
| 58 | 634.0 | 0.71 | 450.12 | 180.05 | 270.07 | 31.51 | 13.50 | 438.33 | 187.85 |
| 59 | 646.7 | 0.71 | 459.13 | 183.65 | 275.48 | 32.14 | 13.77 | 434.07 | 186.03 |
| 60 | 659.6 | 0.7 | 461.71 | 184.68 | 277.03 | 32.32 | 13.85 | 423.80 | 181.63 |
| 61 | 672.3 | 0.7 | 470.95 | 183.38 | 282.57 | 32.97 | 14.13 | 419.69 | 179.87 |
| 62 | 686.2 | 0.7 | 480.37 | 192.15 | 288.22 | 33.63 | 14.41 | 415.61 | 178.12 |
| 63 | 700.0 | 0.7 | 439.97 | 195.99 | 293.98 | 34.30 | 14.70 | 411.53 | 176.39 |

Final current value of new pension deposit: KRW 145.00 million, Surplus new consumption pension: KRW 61.80 million (assuming real 3% return on investment)

### Embodiment 4

Based on the new consumption pension and surplus new consumption pension according to Embodiments 1 to 3, real income was calculated for each income group based on 20 years after retirement, and the results are shown in Table 4.

In this case, the surplus new consumption pension with the redistribution function was calculated on the assumption that 50% is redistributed for the low-income group, 30% is redistributed for the middle-income group and 20% is redistributed for the middle-income group based on the total deposit amount of the surplus new consumption pension, which is the sum of the deposits of all income groups (deposit of surplus new consumption pension in whole life), and the monthly receipt money based on the surplus new consumption pension was calculated by dividing the redistributed amount by 20 years and then again by 12 months.

In addition, the monthly receipt money based on the new consumption pension was calculated by dividing the total amount of the deposits for new consumption pensions, which is the sum of the deposits of all income groups (deposit of new consumption pension in whole life) by 20 years and then again by 12 months.

In addition, the inheritance amount was assumed by calculating the inheritance amount based on the childcare expense of the middle-income group, and it was assumed that the same inheritance amount is given to the low-income group, the middle-income group and the high-income group (the inheritance amount was calculated by compounding the consumption amount of parent generation of the middle-income group×childcare expenses over ages annually (maximum 63 years, minimum 35 years).

In addition, the ratio of parental support expense over ages was calculated as the ratio of childcare expense over ages of the current generation (utilizing data of National Statistical Office)−0.1 by taking into consideration that the income level of the parental generation was lower than that of the current generation.

TABLE A

| | | | Amount of | Amount of | |
|---|---|---|---|---|---|
| | | | deposits | deposits for | Monthly money |
| | | Distribution ratio | for new | surplus new | receipt based |
| | Income at end of | of surplus new | consumption | consumption | on new |
| | pension deposit | consumption | pension in | pension in | consumption |
| Income group | (63 years old) | pension | whole life | whole life | pension |
| Low income group | 260.0 | 0.5 | 6855.0 | 765.0 | 28.6 |
| Middle income | 400.0 | 0.3 | 9420.0 | 2355.0 | 39.3 |
| group | | | | | |
| High income group | 700.0 | 0.2 | 14500.0 | 6180.0 | 60.4 |

| | Monthly receipt | | | |
|---|---|---|---|---|
| | based on surplus | New pension | | Amount of |
| | new consumption | receipt (before | | final pension |
| Income group | pension | inheritance) | Inheritance | receipt |
| Low income group | 19.4 | 48.0 | 69.6 | 117.6 |
| Middle income | 11.6 | 50.9 | 69.6 | 120.5 |
| group | | | | |
| High income group | 7.8 | 68.2 | 69.6 | 137.8 |

### DESCRIPTION OF REFERENCE SYMBOLS

| | |
|---|---|
| 10: New pension account | 20: Purchaser |
| 21 Individual pension recognizer | 22: Family pension recognizer |
| 22 23: individual terminal system | 30: government office |
| 31: Government computer system | 40: Financial institution |
| 41: Financial institution computer system | 50: Selling place |

1. A method of saving a real-name consumption system-based new pension, the method comprising:
a pension account opening step for opening a new pension account for an individual by a computer system of a financial institution or a government office and transmitting an issuing of a pension recognizer associated with the new pension account to the computer system of the government office;
a pension saving step, in which a new consumption pension which is set at a certain rate of an individual consumption is automatically collected and transferred and deposited to the new pension account in the government office or financial institution, and the deposited new consumption pension is saved in an individual pension account of a purchaser who performs a consumption; and
a pension payment step for paying the new pension to the individual through the computer system of the government office from a payment time point until the individual dies depending on an amount of money saved in the new pension account.

2. The method of claim 1, wherein the pension account opening step includes issuing an individual pension recognizer and a family pension recognizer as the pension recognizer.

3. The method of claim 2, wherein the family pension recognizer is configured to register information on a large number of persons having a family relationship and to be linked to new pension accounts of the registered individuals, in which the new consumption pension added to a consumption amount is divided into 1/N per registered persons N such that the new consumption pension is deposited in the new pension account of the registered persons.

4. The method of claim 1, wherein the new consumption pension is added to a supply price of all goods purchased by the individual or family or added to a supply price of services to be provided at a certain rate and compulsorily collected.

5. The method of claim 4, wherein the new consumption pension is set within a range of 0.1 to 20% of the supply price and is added to the supply price such that the consumption pension is included in the consumption amount.

6. The method of claim 1, wherein the new consumption pension includes a surplus new consumption pension.

7. The method of claim 6, wherein the new consumption pension is configured to set an upper limit of an amount of the individual pension to be deposited into the new pension account of the individual and family, in which an amount exceeding the upper limit is set as a surplus new consumption pension, and the amount corresponding to the surplus new consumption pension is automatically deposited into a surplus new consumption pension account other than the individual new pension account.

8. The method of claim 1, wherein the pension saving step includes:
a receipt issuing step of automatically issuing a receipt depending on an input consumption amount after information of the purchaser in the recognizer is recognized by a recognition terminal provided at a selling place;
a consumption information transmitting step of inputting issuing details of the receipt into the computer system of the government office and a terminal system of the individual;
a new consumption pension depositing step of automatically transferring an amount corresponding to the new consumption pension based on the issued receipt from a seller or a card company to the new pension account of the government office or the financial institution; and
an account depositing step of depositing the new consumption pension, which is deposited in the new pension account of the public office or financial institution, into the new pension account of the individual by the computer system of the public office depending on the details of the receipt inputted into the public office.

9. The method of claim 8, wherein the account depositing step further includes a surplus new consumption pension depositing step, in which, when the new consumption pension based on the details of the receipt exceeds an upper limit of a target amount of the individual pension to be deposited into the new pension account, the amount exceeding the upper limit is set as the surplus new consumption pension by the computer system of the government office and transferred to a surplus pension account.

10. The method of claim 8, wherein the pension saving step further includes a deposit history notifying step of notifying the individual of a deposit history where details of deposits are arranged by the computer system of the government office after the account depositing step.

11. The method of claim 10, wherein the deposit history notifying step includes notifying the individual of the details of the deposits, which are deposited from the computer system of the government office into the individual pension account, through a notification device including a mail or an Internet, in which a monthly or quarterly deposit history where the details of deposits of the new consumption pension are arranged is sent to the individual by the computer system of the government office, and the new consumption pension and the surplus new consumption pension are separately posted in the deposit history.

12. The method of claim 8, wherein the receipt issuing step includes automatically issuing the receipt depending on an input consumption amount after information in the individual pension recognizer or family pension recognizer is recognized by the recognition terminal provided at the selling place.

13. The method of claim 12, wherein the recognition terminal includes a card terminal or a pension recognition terminal with a program installed to recognize the information in the individual pension recognizer and family pension recognizer.

14. The method of claim 8, wherein the account depositing step includes:
a comparing step of comparing, by the computer system of the government office, the amount of the new consumption pension of the individual based on the details of the received receipt with the amount of the new consumption pension deposited for the individual;
a depositing step of automatically depositing the amount of the new consumption pension from the computer system of the government office to the individual new pension account through the computer system of the financial institution when the amount of the new consumption pension based on the receipt matches the amount of the deposited new consumption pension;
an error notifying step of notifying the purchaser and seller of an error of the new consumption pension by the computer system of the government office when the amount of the new consumption pension based on the receipt does not match the amount of the deposited new consumption pension; and
a correcting step of correcting the error in response to the error notifying step based on clarification data of the purchaser and seller or details of the deposit for the erroneous new consumption pension.

15. A new pension saving system based on a real-name consumption system, the new pension saving system comprising:
an individual pension recognizer and a family pension recognizer issued to individuals and family upon birth registration;
a recognition terminal installed in a selling place to recognize the individual pension recognizer and the family pension recognizer;
a financial institution computer system configured to issue a new pension account and liked to the individual pension recognizer and the family pension recognizer; and
a government office computer system configured to store information data about the individual pension recognizer and the family pension recognizer and receive details of the new consumption pension transmitted from the recognition terminal through a communication network,
wherein:
the individual pension recognizer or the family pension recognizer are sent to a seller together with a consumption amount when purchasing goods or receiving services from the selling place,
the recognition terminal issues a receipt for the consumption amount depending on information of the individual pension recognizer or the family pension recognizer, information on details of the consumption amount is automatically transmitted to the government office computer system,
the financial institution computer system transmits information on the new consumption pension paid by the seller to the government office computer system, and
the government office the computer system automatically calculate a total amount of the new consumption pension included in the consumption amount to deposit the new consumption pension, which is deposited from a financial institution, into an individual new pension account.

16. The method of claim 2, wherein the new consumption pension is added to a supply price of all goods purchased by the individual or family or added to a supply price of services to be provided at a certain rate and compulsorily collected.

17. The method of claim 16, wherein the new consumption pension is set within a range of 0.1 to 20% of the supply price and is added to the supply price such that the consumption pension is included in the consumption amount.

18. The method of claim 3, wherein the new consumption pension is added to a supply price of all goods purchased by the individual or family or added to a supply price of services to be provided at a certain rate and compulsorily collected.

19. The method of claim 18, wherein the new consumption pension is set within a range of 0.1 to 20% of the supply price and is added to the supply price such that the consumption pension is included in the consumption amount.
